(19) United States
(12) Patent Application Publication
(10) Pub. No.: US 2021/0117947 A1
(43) Pub. Date: Apr. 22, 2021

(54) POINT OF SALE ADJUNCT CONTROL

(71) Applicant: Convepay LLC, Las Vegas, NV (US)

(72) Inventors: Glenn William Semel, Carlsbad, CA (US); Robert Nimon, Hideaway, TX (US)

(73) Assignee: Convepay LLC, Las Vegas, NV (US)

(21) Appl. No.: 17/016,088

(22) Filed: Sep. 9, 2020

Related U.S. Application Data
(60) Provisional application No. 62/897,498, filed on Sep. 9, 2019.

(51) Int. Cl. G06Q 20/20; G06Q 10/10; G06K 7/14; G06K 9/78

(52) U.S. Cl. CPC G06Q 20/204; G06Q 10/10; G06K 9/78; G06K 7/1447; G06Q 20/208

(57) ABSTRACT

An adjunct control system includes a point of sale workflow interface through which visual aspects of a point of sale workflow are received, an adjunct controller that processes the received visual aspects of the workflow to detect a transaction type and a transaction amount, and a credit card terminal interface through which the controller interacts with a credit card terminal to complete a transaction captured in the workflow.

### CROSS REFERENCE TO RELATED APPLICATIONS

This application claims the benefit of U.S. provisional patent application Ser. No. 62/897,498 [COVE-0001-P01] filed Sep. 9, 2019, the entirety of which is hereby incorporated by reference.

A system and accompanying method providing a controller to adjunct point of sales systems.

### BACKGROUND

### Field

The present disclosure relates to a method of enhancing point of sale systems. In particular, the present disclosure relates to a method of enhancing the functionality of a point of sale system, such as that found, without limitation within a retail environment, without the need to alter either the existing point of sale hardware or to alter the software loaded thereon.

### Description of Related Art

Retailers use point of sale hardware and software systems (POS systems) to streamline sales operations and to allow them to process sales, handle payments, and store transactions for later retrieval. POS systems generally comprise a number of elements including point of sale terminals that are connected to a controlling server (the “back-office” servers) using an internal network connection. In a large retail environment, such as a supermarket, there may be a plurality of such POS terminals in communication with the back-office servers. It is noted that the back-office servers may be located locally (e.g. within the store) or remotely (in which case the POS terminals may be in communication with the back-office servers via a local communications network and a further communications network such as the Internet).

POS systems represent a very expensive investment for retailers. Retailers choose their POS provider after a lengthy process, and once the investment is made, they upgrade it only infrequently.

Extending the functionality of POS systems has always been a challenge but the recent increases in competing functionalities have put tremendous pressure on retailers to look at ways at supporting new functions as quickly as possible. It has always been possible to redesign and develop the POS software so that it supports new features but this option is costly and time consuming.

Further, these proprietary POS systems create a “lock-in” where the provider becomes the only source to perform operations that center around the point of sale. For example, a point of sale terminal configured to accept data entry for a consumer purchase also becomes the only method to accept and process a credit card for the transaction. Prior to this invention, when a more desirable credit processing method becomes available the retailer depends on the POS system provider to offer such method.

Another issue associated with this “lock-in” is the ability for the POS provider to force the retailer to pay for an expensive upgrade under the guise of needed security changes for the credit processing aspect of the POS system. In addition to adding new functionality, it is therefore seen as an advantage in combatting these “lock-in” issues in the current market to enable functions such as the aforementioned credit processing to be separated from the existing POS system.

Methods in the prior art exist for a controller to listen to the communications between a POS system and various other systems that function in the point of sale and inventory control process, such as a local or cloud host server. At various points in the transaction, the POS system communicates with the host server. One of the host servers may function to aid in processing the credit card data by enabling communication with a device that accepts the credit card scan, or the POS system may directly communicate with the device. Today the listening of these communication transactions is limited to those transactions that are supported in published protocols operating in the network or on direct serial interfaces. Adherence to these protocols creates another form of “lock-in” since addition of new features and/or the act of shifting existing features from the POS both rely on the POS vendor and the existing POS protocols to provide the appropriate underlying support.

What is needed is, among other things, a method to adjunct these POS systems that does not rely on changes in software or hardware from the POS vendor and does not rely on the existing communication control protocols between the POS systems and their connected devices and host controllers.

### SUMMARY

In embodiments, a solution to the above problems of adding or changing the functionality of the POS system to facilitate transaction execution may include an adjunct controller that can monitor visual aspects of the POS sale workflow to provide a desired function and/or enhancement, such as controlling a credit card terminal and the like. The adjunct controller may provide the enhancement within the adjunct controller itself or via integration with other existing systems to provide an “enhancement integration”. The various preferred embodiments of the present disclosure are readily adapted for use with a variety of point of sale systems and a variety of integrations. For example, the controller could adjunct a Paladin™ or Epicor™ POS system providing an enhancement integration with, for example a Clover Mini™ for the credit card processing. Used in this manner, the controller may extend and/or effect a switch of functionality of the credit card processing off of the Paladin™ or Epicor™ system and onto the Clover Mini™.

The adjunct controller may be manipulated and programmed without any obvious effect upon the existing POS systems. Additionally, installation and operation of the adjunct controller does not require any hardware or software modifications of the existing computer network that supports the POS systems. Aspects of the preferred embodiments include a very low entry cost, low installation/maintenance cost, and extensibility.

A first aspect of the methods and systems of adjunct control is an adjunct method control program that runs as an application on an application layer of a computer that operates according to an operating system on the operating system, kernel layer, that has communication ports according to an operating system layer, the adjunct method executing a process of: an image capture step in which the computer acquires images using a port (e.g., display, communication, and similar port) of the POS system sales transaction; and an image analysis step in which at the application layer the computer decodes the images and extracts data; and a data analysis step during which the state of the sales transaction and the data associated with the transaction is processed to determine enhancement or integration steps; and one or more integration steps in which the data from data analysis step is processed to effect the enhancement.

In another aspect, the integration step involves sending the data from the data analysis step via one of the operating system communication ports to an integration device that provides that enhanced function.

In yet another aspect, the integration step enhancement function is executed on the adjunct controller.

The foregoing and other features and advantages of the present disclosure will be apparent from the following more detailed description of preferred embodiments of adjunct POS transaction control, as illustrated in the accompanying drawings.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

Preferred embodiments of the present invention will be described via references to the appended drawings, where like designations denote like elements, and:

FIG. 1 is a block diagram of an adjunct controller linking a proprietary POS device to a proprietary terminal through a direct local connection according to a preferred embodiment of the present invention;

FIG. 2 is a block diagram of an adjunct controller linking a proprietary POS device to a proprietary terminal through a web service according to a preferred embodiment of the present invention; and

FIG. 3 is a block diagram of an adjunct controller that may function in a preferred embodiment such as that shown in FIGS. 1 and/or 2.

### DETAILED DESCRIPTION

In embodiments, systems and methods are provided for controlling aspects of a point-of-sale (POS) transaction with an adjunct controller linked to an existing POS transaction workflow processor. The transaction workflow processor is typically an electronic cash register, but may take other forms. The POS transaction processor is itself typically linked to a POS transaction display and optional keyboard used by a customer service representative to control the sale workflow. An objective of the present methods and systems is to monitor and process the images sent via the link between the POS transaction workflow processor and the POS transaction workflow display and therefore facilitate tracking of the state of the sale transaction workflow. In embodiments, the present invention uses the information derived from this monitoring to, among other things determine points in the workflow where, for example programmed enhancements can be provided.

In embodiments, the adjunct controller is used to monitor the transaction workflow and determine when the state of that workflow has reached the point in the transaction where the credit card processing aspect of the workflow is required and the amount of the sale has been determined. Although this embodiment references a credit card, any form of credit payment, such as a mobile phone, secure transaction device, proximity transaction device, and the like may be the source of payment in a POS transaction herein. This and other embodiments allow the adjunct controller to control the credit capture terminal to cause the credit processing, thereby removing said control from the proprietary POS transaction workflow processor. According at least to this embodiment, the adjunct controller is controlling the credit capture terminal, including directly and indirectly controlling the terminal.

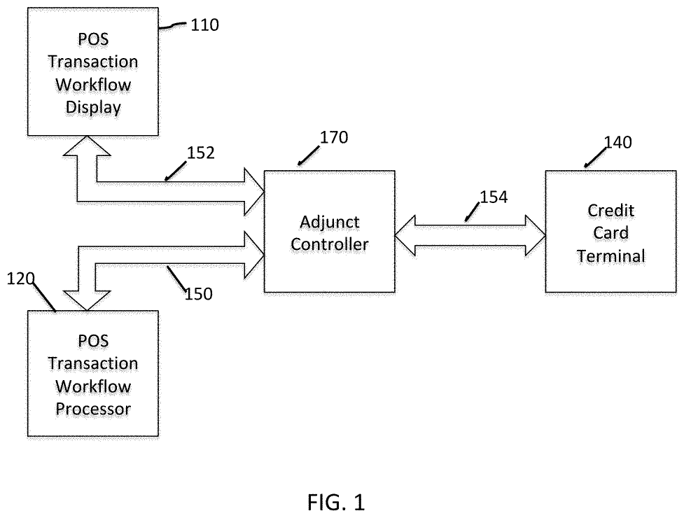

FIG. 1 shows a POS transaction workflow processor 120 linked to an adjunct controller 170 through a link 150. The figure shows the adjunct controller also linked to a POS transaction workflow display through a link 152 and linked to a credit card terminal through a link 154. The links 150 and 152 may be of any type of physical or logical means known in the art of connecting a processor to a display. This includes, but is not limited to, direct connections via High Definition Multimedia Interface (HDMI) and/or Video Graphics Array (VGA). It is anticipated that many alternative methods and materials for connecting processors (and other forms of computer systems) to displays will be readily adapted for use with the present invention. This would include those methods and materials to be developed in the future. The adjunct controller transparently uses information transferred between the processor and display to monitor the progress of the POS transaction. The link 154 between the adjunct controller and the credit card terminal 140 is used by the adjunct controller to send commands to the credit card terminal and to receive status updates from the credit card terminal. Link 154 may be of any type of physical or logical means known in the art for connecting computer systems. This includes, but is not limited to, direct connections, Internet connections, Intranet connections and other forms of wired and wireless connections. It is anticipated that many alternative methods for connecting computer systems will be readily adapted for use with the present invention. This would include those methods to be developed in the future.

In embodiments, the adjunct controller 170 monitors images or portions thereof transferred from the POS transaction workflow processor 120 to the POS transaction workflow display. Based at least in part on this monitoring, the adjunct controller sends commands to the credit card terminal 140. The type of credit card terminal may be of any type known in the art for processing credit card transactions and that, for example supports computer-to-computer interfaces, such as an Application Programming Interface (API) where such API provides for commands to process various credit transactions such as to request a credit card transaction for a given dollar amount, determine a final disposition of said transaction, optionally provide an additional means for cancellation of the requested transaction, and the like.

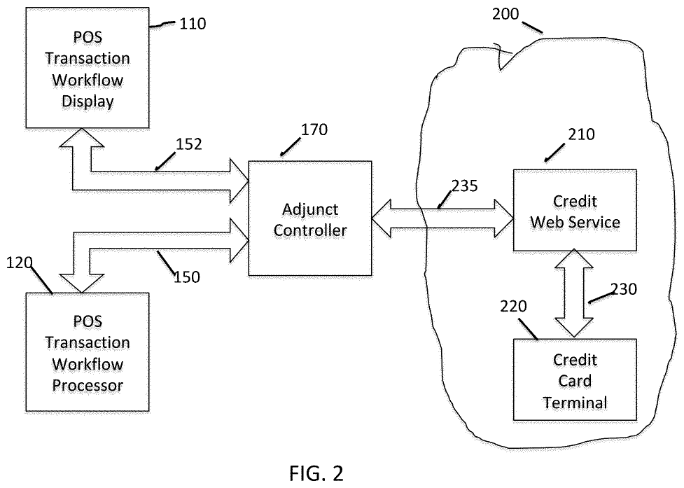

FIG. 2 shows alternative embodiments for the adjunct controller 170 to control an alternative credit card terminal 220. For this exemplary embodiment, the adjunct controller is connected to a credit web service 210 though a link 235, as an alternative to the direct connection 154 that was shown is FIG. 1. The credit web service may be of any type known in the art for processing credit transactions that supports controlling credit card terminal 220 through a link 230. The credit card terminal may be of any type known in the art that supports being controlled by a web service through a link known in the art to support connecting web services with terminals.

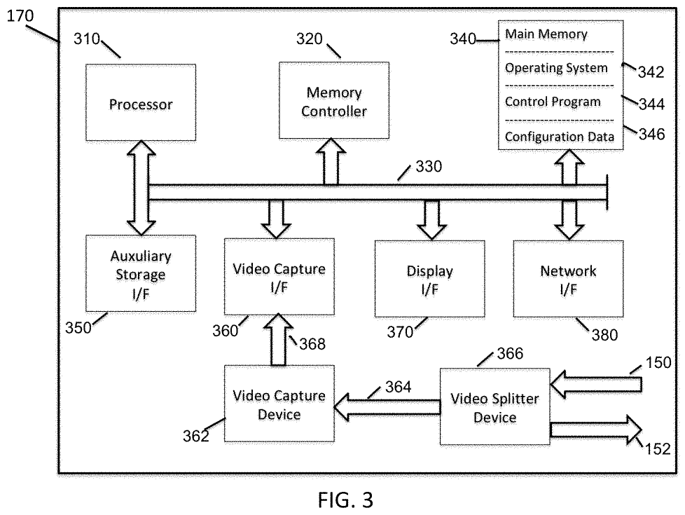

FIG. 3 displays an exemplary, non-limiting embodiment of the adjunct controller 170 with additional detail to better describe its operation. A controller 170 in accordance with a preferred embodiment of the present invention may comprise a low-cost, small form factor (e.g., credit-card sized) computer that supports a processor communication link (e.g., bus) 330 connecting a memory controller 320, a main memory 340, auxiliary storage interface 350, a video capture interface 360, a display interface 370, and a network interface 380. In a preferred embodiment, the processor, memory controller, auxiliary storage interface, display interface, and network interface are all provided by the Raspberry PI 3B (PI) single board computer but those skilled in the art will appreciate that the methods and apparatus of the present invention be applied by another comparable computer system. In the context of the PI, the network interface 380 is either Ethernet, Wifi, Bluetooth, or some combination (the Raspberry Pi 3B+ features dual-band IEEE 802.11b/g/n/ac WiFi, Bluetooth 4.2, and Gigabit Ethernet—limited to approximately 300 Mbit/s by the USB 2.0 bus between it and the SoC). Further, in this context, the video capture interface 360 is USB 2.0 connected to a video capture device 362 via a USB link 368. In a preferred embodiment of the present invention, the video capture device 362 is an IU 012A HD USB Capture HDMI and the video splitter 366 is a HS306-BK HDMI splitter. An aspect of the adjunct controller is to receive video signal input through link 150 in the video splitter 366, generate two copies of that signal output through link 152, which is connected to the POS transaction workflow display 110, and through link 364 which is connected to video capture device 362. The video capture device 362 converts the video signal from the format in link 364 to the format in link 368. In a preferred embodiment of the present invention, link 364 is of format HDMI and link 368 is of format USB. In this embodiment then, the video capture interface 360 is a USB 2.0 interface.

In a preferred embodiment of the present invention, the processor 310 is executing for the operating system 342 the Raspbian Operating System, which is a distribution of Debian Linux that resides in main memory 340. The main memory also contains a control program 344 that runs as an application on an application layer of the processor that operates according to the operating system, kernel layer. The representative concept of the control program is to execute a process of: an image capture step by reading video frames from the video capture interface 362 via services available at the operating system kernel layer; and an image analysis step in which the adjunct controller decodes the images and extracts data; and a data analysis step during which the state of the sales transaction and the data associated with the transaction from the image analysis step is processed to determine enhancement or integration steps; and one or more integration steps in which the data from data analysis step is processed to effect the enhancement.

In a preferred embodiment of the present invention, the enhancement provided by the integration step is a credit transaction as described above. Those skilled in the art will appreciate that other forms of enhancement to the POS transaction workflow may be provided, such as facilitating application for providing a line of credit, handling offers that may impact (e.g., offset) some of the costs of the transaction, and the like. Enhancements may involve integration steps to devices other than credit card terminals or may be performed entirely within the adjunct controller itself via additional control program features.

In a preferred embodiment of the present invention, the image analysis step converts the image to text data recognizable as pertaining to the POS transaction workflow. In this embodiment, the image analysis step determines whether the image (and therefore the display view of the transaction workflow) contains the sales transaction dollar amount. The data analysis step then manages a control program state variable that reflects the state of the analysis goal which in the preferred embodiment reflects that the control program 344 is either scanning for an amount or has already found an amount and is waiting for the integration step to complete. If an amount is detected and the control program 344 is scanning for an amount, then the integration step is initiated.

As an example, if an amount is not detected and the control program 344 is awaiting the integration step, then the integration step is cancelled. Other actions may be taken responsive to the conditions of this example, such as performing a transaction recovery step to attempt to align the control program step with the scanning activity and the like.

### Machine Embodiments

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are contemplated in embodiments of the present disclosure.

What is claimed is:

1. An adjunct control system comprising:
a point of sale workflow interface through which visual aspects of a point of sale workflow are received;
an adjunct controller that processes the received visual aspects of the workflow to detect a transaction type and a transaction amount; and
a credit card terminal interface through which the controller interacts with a credit card terminal to complete a transaction based on the transaction type and transaction amount.

2. A method comprising:
capturing an image of a Point of Sale (POS) transaction using an image capture port of an adjunct controller;
decoding the captured image;
extracting data in the decoded image that is representative of a workflow state of the POS transaction;
determining a readiness for enhancement of the POS transaction based on the extracted data;
processing the extracted data and the determined readiness for enhancement of the POS transaction with a processor of the adjunct controller to determine an integration step action; and
based on the determined integration step action, integrating the extracted data in an integration step action that effects enhancement of the POS transaction.

3. The system of claim 1, wherein the point of sale workflow interface comprises a receiving link that is constructed to receive data comprising the visual aspects, the data formatted for rendering on an electronic display.

4. The system of claim 3, wherein the point of sale workflow interface further comprises a propagation link constructed to present the data compromising the visual aspects on a point of sale display output port of the adjust control system.

5. The method of claim 2, wherein determining a readiness for enhancement comprises detecting a transaction amount in the extracted data.

6. The method of claim 2, wherein to determine an integration step action comprises determining if a transaction dollar amount is visible in the extracted data.

7. The method of claim 2, wherein to determine an integration step action comprises waiting for an integration step to complete.

8. The method of claim 2, wherein enhancement of the POS transaction includes facilitating application for providing a line of credit.

9. The method of claim 2, wherein enhancement of the POS transaction includes handling offers that impact a transaction amount depicted in the extracted data.

10. An adjunct control device comprising:
a point of sale workflow interface through which visual aspects of a point of sale workflow are received;
a processor that detects a transaction type and a transaction amount in the visual aspects and processes a portion of the visual aspects to facilitate enhancement of the workflow;
a point of sale display interface that presents a portion of content received through the point of sale workflow interface; and
a transaction terminal interface through which the device communicates at least the transaction amount as adjusted by the enhancement of the workflow and receives transaction updates.

11. The device of claim 10, wherein the point of sale workflow interface comprises a receiving link that is constructed to receive data comprising the visual aspects, the data formatted for rendering on an electronic display.

12. The device of claim 11, wherein the point of sale workflow interface further comprises a propagation link constructed to present the data compromising the visual aspects on a point of sale display output port of the adjust control system.

13. The device of claim 10, wherein to facilitate enhancement of the workflow is based on the detected transaction amount.

14. The device of claim 10, wherein to facilitate enhancement of the workflow is based on the detected transaction type.

15. The device of claim 10, wherein to facilitate enhancement of the workflow includes determining if an integration step is complete.

16. The device of claim 10, wherein to facilitate enhancement of the workflow includes facilitating application for providing a line of credit.

17. The device of claim 10, wherein to facilitate enhancement of the workflow includes handling offers that impact a transaction amount depicted in the visual aspects.

18. The device of claim 10, wherein the point of sale workflow interface receives images being transferred from a point of sale workflow controller to a point of sale workflow display.

19. The device of claim 18, wherein the processor detects a transaction type and a transaction amount in the visual aspects via image analysis of the images being transferred from the point of sale workflow controller to the point of sale workflow display.

20. The device of claim 10, wherein the transaction terminal interface facilitates use of an Application Programming Interface for communicating the transaction amount.
